(19) United States
(12) Patent Application Publication
(10) Pub. No.: US 2010/0155501 A1
(43) Pub. Date: Jun. 24, 2010

(54) Self-controllable device for sprinkle arrangement

(76) Inventor: Chin-Hsiung Lien, El Monte, CA (US)

Correspondence Address: DAVID AND RAYMOND PATENT FIRM, 108 N. YNEZ AVE., SUITE 128, MONTEREY PARK, CA, 91754, US

(21) Appl. No.: 12/317,565

(22) Filed: Dec. 22, 2008

(51) Int. Cl. B05B 15/06

(52) U.S. Cl. 239/67

(57) ABSTRACT

A self-controllable device for a sprinkle arrangement of a water sprinkle system includes a pipe joint and a water regulator. The pipe joint has a water channel adapted for operatively coupling with the water sprinkle system to guide a water flow passing from the water pipe line to the water channel. The water regulator, which is coupled with the pipe joint, includes a regulator body having a water detouring passage operatively communicating with the water channel for guiding the water flow passing to one of the sprinkle heads, and a flow adjuster operatively extended within the water detouring passage for selectively controlling the water flow passing from the water channel to the water detouring passage. Therefore, when the flow adjustor is actuated for blocking the water flow passing to the water detouring passage, the respective sprinkle head is shut off while other sprinkle heads are remained operated.

### BACKGROUND OF THE PRESENT INVENTION

1. Field of Invention

The present invention is related to a sprinkle system, and more particularly to a self-controllable device for a sprinkle arrangement which can control each sprinkle head individually.

2. Description of Related Arts

To maintain a beautiful lawn yard or a garden, watering the grass and plants regularly is the most important. For a small area of lawn, such as a front yard of a residential house, people can water the grass as simple as using a water pipe. But it needs a person to take in charge. For larger area, such as a park or street side, and also for many residential houses, automatically controlled watering systems are needed. Generally, this type of watering systems has a plurality of sprinkle heads distributed evenly within the area need be watered. Each sprinkle head is connected with a pipe, normally buried under ground, for providing water. All the pipes are divided from a main pipe which is controlled by a central controller. This central controller is programmed to turn on or shut off the water supply of the main pipe automatically.

There is a problem of this kind of watering system. All the pipes are extended or divided from the main pipe, which means they are all communicatively connected. As a result all the sprinkle heads sustain the same water pressure. If one sprinkle head is broken, the whole pressure will push the water out through it. Only by shutting off the main pipe can stop the water. Therefore, the whole system will not work until the particular one sprinkle head is repaired. The user may have to wait for a long time before the whole system can work again.

Another problem of this kind of watering system is that the sprinkle head can not be controlled individually. Different plants need different amount of water. The optimum time of watering may also be different. But for the current using watering system, the whole area will be watered at the same time with the same amount.

Another problem of this kind of watering system is it is easy to be broken. Some sprinkle heads with the pipes are buried at the edges and corners of the yard. It is quite easy for people to walk on them, or for cars to drive over them. All these problems need to be solved for a better performance of a watering system.

### SUMMARY OF THE PRESENT INVENTION

The main object of the present invention is to provide a self-controllable device for a sprinkle arrangement which is individually controllable to control the sprinkle head.

Another object of the present invention is to provide a self-controllable device for a sprinkle arrangement, wherein each sprinkle head is individually switched off without interfering with the rest of the sprinkle heads.

Another object of the present invention is to provide a self-controllable device for a sprinkle arrangement which is easy to control.

Another object of the present invention is to provide a self-controllable device for a sprinkle arrangement which is not expensive.

Another object of the present invention is to provide a self-controllable device for a sprinkle arrangement which is adapted for providing an independent, environmentally-friendly and economical control to the sprinkle head.

Another object of the present invention is to provide a self-controllable device for a sprinkle arrangement which can be programmed to automatically activate each individual sprinkle head.

Another object of the present invention is to provide a self-controllable device for a sprinkle arrangement which can be managed to alternate watering area.

Another object of the present invention is to provide a self-controllable device for a sprinkle arrangement which provides a predetermined flexibility for the sprinkle head to permit the sprinkle head being moved so as to prevent the sprinkle head from being broken by an external force.

Another object of the present invention is to provide a self-controllable device for a sprinkle arrangement incorporated with a water sprinkle system, which does not significantly alter the original structure of the water sprinkle system, so as to minimize the manufacturing and marketing costs of the water sprinkle system incorporating with the self-controllable device for a sprinkle arrangement.

Another object of the present invention is to provide a self-controllable device for a sprinkle arrangement incorporated with a water sprinkle system, wherein no complicated mechanical and electrical process are involved in installing and mounting the self-controllable device for a sprinkle arrangement to the water sprinkle system.

In order to accomplish the above objects, the present invention provides a self-controllable device for a sprinkle arrangement for a water sprinkle system which comprises a water pipe line and one or more sprinkle heads, comprising:

a pipe joint having a water channel adapted for operatively coupling with the water sprinkle system to guide a water flow passing from the water pipe line to the water channel; and

a water regulator, which is coupled with the pipe joint, comprising a regulator body having a water detouring passage operatively communicating with the water channel for guiding the water flow passing to one of the sprinkle heads, and a flow adjuster operatively extended within the water detouring passage for selectively controlling the water flow passing from the water channel to the water detouring passage in such a manner that when the flow adjustor is actuated for blocking the water flow passing to the water detouring passage, the respective sprinkle head is shut off while other the sprinkle heads are remained operated.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a self-controllable device for a sprinkle arrangement for a water sprinkle system according to a first preferred embodiment of the present invention.

FIG. 2 is a sectional view of the self-controllable device for a sprinkle arrangement according to the above first preferred embodiment of the present invention.

FIG. 3 illustrates a first alternative mode of the self-controllable device for a sprinkle arrangement according to the above first preferred embodiment of the present invention.

FIG. 4 illustrates a second alternative mode of the self-controllable device for a sprinkle arrangement according to the above first preferred embodiment of the present invention.

FIG. 5 is a perspective view of a tubular sleeve of the self-controllable device for a sprinkle arrangement according to the above first preferred embodiment of the present invention.

FIG. 6 is a perspective view of a self-controllable device for a sprinkle arrangement for a water sprinkle system according to a second preferred embodiment of the present invention.

FIG. 7 is a front sectional view of the self-controllable device for a sprinkle arrangement according to the above second preferred embodiment of the present invention.

FIG. 8 is a side sectional view of the self-controllable device for a sprinkle arrangement according to the above second preferred embodiment of the present invention.

FIG. 9 illustrates the application of the self-controllable device to control the watering area according to the above second preferred embodiment of the present invention.

### DETAILED DESCRIPTION OF THE PREFERRED EMBODIMENT

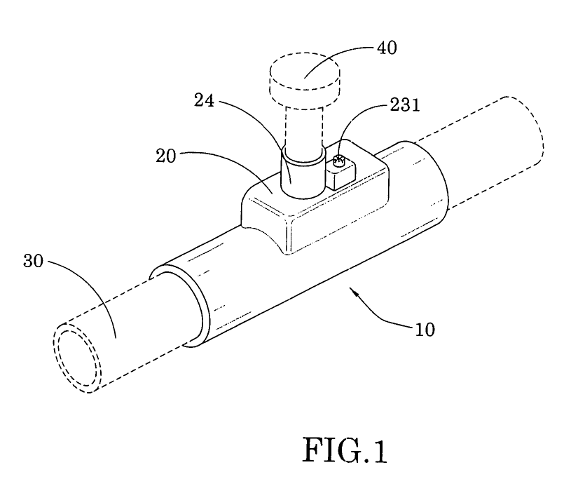

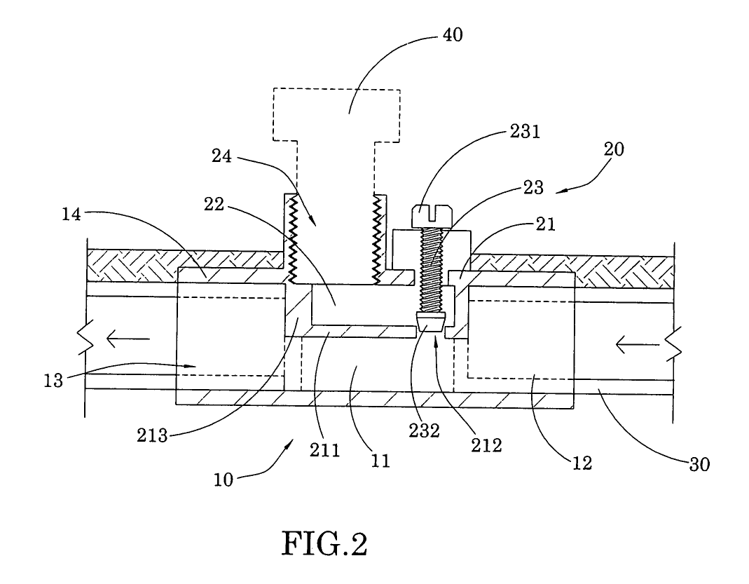

Referring to FIGS. 1 to 2 of the drawings, a self-controllable device for a sprinkle arrangement according to a first preferred embodiment of the present invention is illustrated, wherein the self-controllable device for a sprinkle arrangement is adapted for incorporating with an existing water sprinkle system for controlling each of the sprinkle heads 40.

The self-controllable device for a sprinkle arrangement comprises a pipe joint 10 and a water regulator 20. The pipe joint 10 comprises a water channel 11, a water inlet 12 and a water outlet 13. The pipe joint 10 is coupled with the water pipeline 30 of the water sprinkle system through the water inlet 12 and the water outlet 13 respectively. In this manner, the water flow within the water pipeline 30 is guided by the pipe joint 10 to flow into the water channel 11 of the pipe joint 10 through the water inlet 12, and flow out of the water channel 11 through the water outlet 13. Accordingly, the water outlet 13 of the pipe joint 10 can be a closed end as the terminal of the water sprinkle system.

The water regulator 20 is adapted to be communicatively coupled with the water channel 11 of the pipe joint 10 and with the sprinkle head 40 of the water sprinkle system. The water regulator 20 comprises a regulator body 21, a water detouring passage 22, a flow adjustor 23, and a sprinkle opening 24. The water flow in the water channel 11 of the pipe joint 10 can enter into the water detouring passage 22 of the regulator body 21 under the control of the flow adjustor 23. The sprinkle opening 24 has an inner threaded portion adapted to couple with the sprinkle head 40. Preferably, the sprinkle head 40 can be screw onto the regulator body 21 through the sprinkle opening 24. When the flow adjustor 23 is open, the water flow can pass through the water detouring passage 22, and be sprayed out of the sprinkle head 40 by water pressure. When the flow adjustor 23 shuts off the water regulator 20, there is no water flow entering into the detouring passage. But the water flow can still pass through the pipe joint 10 to reach the other sprinkle heads 40.

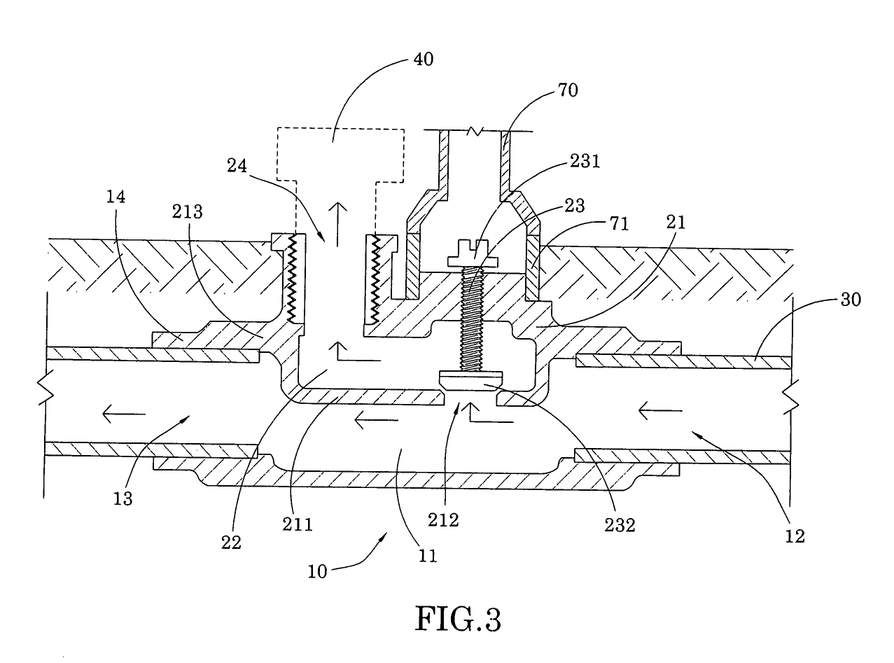

The pipe joint 10 has a surrounding wall 14 to define the water channel 11, water inlet 12, and water outlet 13. The regulator body 21 also has a partition wall 213 and a side wall 211 to define the water detouring passage 22. Referring to FIGS. 2 and 3, the side wall 211 of the regulator body 21 is integrally extended from the surrounding wall 14 of the pipe joint 10 inwardly. The partition wall 213 is integrally supported by the side wall 211 of the regulator body 21 and is suspended within the surrounding wall 14 of the pipe joint 10. In this way the water detouring passage 22 of the water regulator 20 is divided from the water channel 11.

The regulator body 21 also comprises a water valve slot 212 on the partition wall 213. The water valve slot 212 is adapted to allow the water flow in the water channel 11 to pass through to enter into the water detouring passage 22 of the water regulator 20. The flow adjustor 23 is coupled with the water valve slot 212 for adjusting the water flow passing through the water valve slot 212. In a preferred embodiment of the present invention, the flow adjustor 23 comprises a controlling end 231 and a stopper end 232. The flow adjustor 23 extends inside the water detouring passage 22 with the stopper end 232 engaged with the water valve slot 212. The controlling end 231 of the flow adjustor 23 extends outside of the water detouring passage 22 and can be accessed by the user. When the user actuates the controlling end 231, the stopper end 232 can be selectively adjusted to engage with the water valve to control the rate of the water flow passing into the water detouring passage 22 or totally seal the water valve slot 212 to block the water flow. In this way, the water flow of each sprinkle head 40 can be controlled individually. For example, when the sprinkle head 40 is broken, the flow adjustor 23 can shut off the water from any leaking.

In a preferred embodiment of the present invention, the flow adjustor 23 has one or more screw thread. The regular body also has one or more corresponding grooves. So the flow adjustor 23 and the regular body are coupled together by screw. The controlling end 231 is formed as a screw head for the user to use a screw driver or alike to rotate the flow regulator. Then the flow adjuster will be driven to move forward or backward according to the water valve slot 212. As a result the stopper end 232 of the flow adjustor 23 can fully seal the water valve, or selectively leave a through passage for the water flow to pass through.

It is worth mentioning, the controlling end 231 of the flow adjustor 23 must be explored for the user to reach when the self-controllable device for a sprinkle arrangement is embedded under ground with the water sprinkle system. Referring to FIG. 2, when the sprinkle arrangement is not embedded very deep, in a preferred embodiment, the flow adjustor 23 is long enough to extend above the ground, so the user can adjust the controlling end 231 directly.

Referring to FIG. 3, when the self-controllable device for a sprinkle arrangement is embedded relatively deep under the ground, the controlling end 231 of the flow adjustor 23 is not long enough to expose above the ground. In this case, the self-controllable device for a sprinkle arrangement further comprises a tubular sleeve 70 to protect the controlling end 231 of the flow adjustor 23 from being buried under the ground.

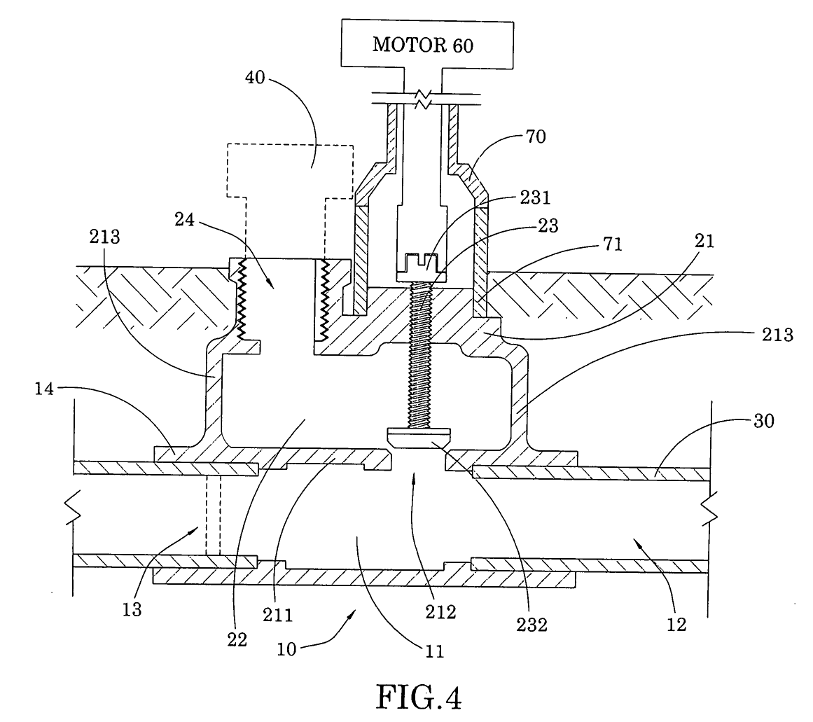

Referring to FIG. 4, in an alternative embodiment of the present invention, the side wall 211 of the regulator body 21 is integrally and upwardly extended from the surrounding wall 14 of the pipe joint 10. In this manner, the water detouring passage 22 of the water regulator 20 is above the water channel 11 of the pipe joint 10. The surrounding wall 14 of at the top of the pipe joint 10 also acts as the partition wall 213 of the regulator body 21. Because the water regulator 20 and the coupled sprinkle head 40 are in a higher position, this embodiment can be used for water sprinkle system buried deeper under ground which is not easy to be broken.

As shown in FIG. 4, since the water pipeline 30 is way below the ground level, the user may not be able to easily actuate the controlling end 231 of the flow adjustor 23.

Accordingly, the controlling end 231 can also be actuated by electric motors 60. The output shaft of the electric motor 60 is engaged with the controlling end 231 of the flow adjustor 23 to rotate it. In this way the flow adjustor 23 can be automatically controlled, as shown in FIG. 4. The electric motor 60 of each self-controllable device for a sprinkle arrangement can also be controlled and programmed by a central controller or a computer. So the central controller or the computer can active the electric motor 60 of each self-controllable device for a sprinkle arrangement individually to turn on/off the water spray of each sprinkle head 40 at selected time. The spray rate can also be selectively controlled.

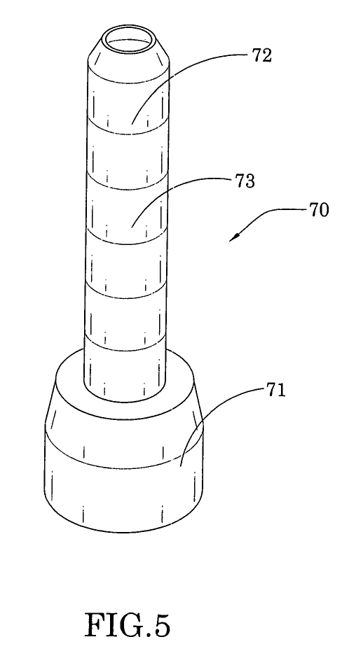

Referring to FIG. 5, the tubular sleeve 70 comprises a bottom end 71 and a top opening end 72. The bottom end 71 is adapted to be coupled with the regulator body 21 to encircle the controlling end 231 of the flow adjustor 23. The top opening end 72 of the tubular sleeve 70 then extends above the ground. In this manner, the user can still use screw driver or alike to actuate the controlling end 231 of the flow regulator through the top opening end 72 of the tubular sleeve 70. In a preferred embodiment of the present invention, the tubular sleeve 70 is form integrally in a relatively long length. The user can tailor the length but cutting the top regarding the particular depth of the sprinkle arrangement is embedded. A plural of breakable scores 73 are pre-engraved for the use's convenience to shorten the length of the tubular sleeves 70.

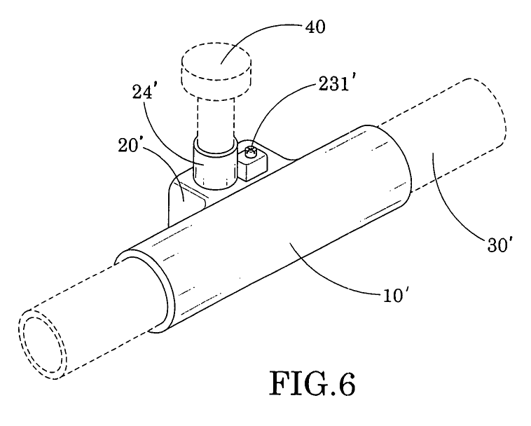

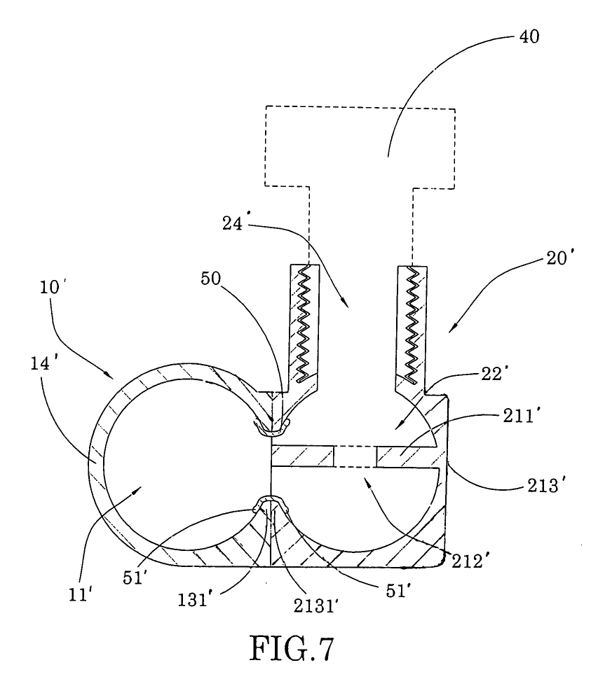

Referring to FIGS. 6 and 7, in a second embodiment of the present invention, the water regulator 20′ and the pipe joint 10′ are formed individually and are coupled side by side. The self-controllable device for a sprinkle arrangement further comprises a tubular flexible joint 50′ to couple the water regulator 20′ and the pipe joint 10′ together sealedly and pivotally. Referring to FIG. 7, the surrounding wall 14′ of the pipe joint 10′ has a first flat surface 131′. The side wall 211′ of the regulator body 21′ has a second flat surface 2131′ correspondingly. Both the first flat surface 131′ and the second flat surface 2131′ have a through opening. When the water regulator 20′ and the pipe joint 10′ are coupled together with the first flat surface 131′ and the second flat surface 2131′ engaged with each other, the opening on both the first and second flat surface 2131′ form a though channel to allow the water flow passing from the water channel 11′ of the pipe joint 10′ into the water regulator 20′.

The tubular flexible joint 50′ has a ring like structure. At each edge it has a sealing end 51′. The tubular flexible joint 50′ is flexible, and the two sealing ends 51′ are intend to bend towards each other, so they can lock the inner said of the surrounding wall 14′ of the pipe joint 10′ through the opening of the first flat surface 131′, and the inner side of the side wall 211′ of the water regulator 20′ through the opening of the second flat surface 2131′ when it is coupled with the pipe joint 10′ and the water regulator 20′. In this way the two openings on the first and second flat surfaces 2131′ are sealed. Because the first and second flat surfaces 2131′ are flat, when they are engaged, the pipe joint 10′ and the water regulator 20′ is still slidable. So the regulator body 21′ is able to be pivotally shifted with respect to the pipe joint 10′ with an angle. For example, the sprinkle head 40 coupled with the water regulator 20′ may not be perpendicular to the water pipeline 30 coupled with the pipe joint 10′. This structure gives the sprinkle arrangement more flexibility to be used with water sprinkle system. For example, the angle of the sprinkle head 40 can be adjusted regarding the topography of the land. Also, because the regulator body 21′ can be shifted pivotally, when outside pressure is applied, such as a car, the regulator body 21′ will bend to avoid breaking the pipe joint 10′ and the pipeline.

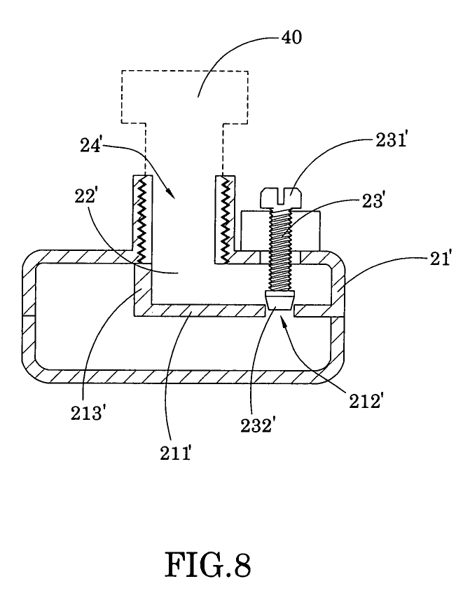

As shown in FIG. 8, the regulator body 21′ also comprises a water valve slot 212′ on the partition wall 213′. The water valve slot 212′ is adapted to allow the water flow in the water channel 11′ to pass through to enter into the water detouring passage 22′ of the water regulator 20′, so as to guide the water flow to the sprinkle opening 24′. The water regulator 20′ also comprises a flow adjustor 23′ coupled with the water valve slot 212′ for adjusting the water flow passing through the water valve slot 212′. In a preferred embodiment of the present invention, the flow adjustor 23′ comprises a controlling end 231′ and a stopper end 232′. The flow adjustor 23′ extends inside the water detouring passage 22′ with the stopper end 232′ engaged with the water valve slot 212′. The controlling end 231′ of the flow adjustor 23′ extends outside of the water detouring passage 22′ and can be accessed by the user. When the user actuates the controlling end 231′, the stopper end 232′ can be selectively adjusted to engage with the water valve to control the rate of the water flow passing into the water detouring passage 22′ or totally seal the water valve slot 212′ to block the water flow. In this way, the water flow of each sprinkle head 40 can be controlled individually. For example, when the sprinkle head 40 is broken, the flow adjustor 23′ can shut off the water from any leaking.

In a preferred embodiment of the present invention, the flow adjustor 23′ has one or more screw thread. The regular body also has one or more corresponding grooves. So the flow adjustor 23′ and the regular body are coupled together by screw. The controlling end 231 ′ is formed as a screw head for the user to use a screw driver or alike to rotate the flow regulator. Then the flow adjuster will be driven to move forward or backward according to the water valve slot 212′. As a result the stopper end 232′ of the flow adjustor 23′ can fully seal the water valve, or selectively leave a through passage for the water flow to pass through.

In summary, the self-controllable device for a sprinkle arrangement of the present invention provides the user a lot of flexibility, reliability, and controllability. A water sprinkle system usually has a plurality of sprinkle heads 40. These sprinkle heads 40 are exposed above the ground so they are very easy to be broken. Using the self-controllable device for a sprinkle arrangement of the present invention, if any one sprinkle head 40 is broken, the user can easily block the water valve slot 212 of the water regulator 20 by actuating the flow adjustor 23 of the sprinkle arrangement coupled with this particular sprinkle head 40. All the rest sprinkle heads 40 of the water sprinkle system can still work normally.

For a park or a yard of a house, there may be many different kinds of plants. These plants may need different amount of water according to their nature. At different seasons, the water needed is also different. Also, at the same spot different plants may be grown from time to time. Accordingly, the water sprinkle system is designed with respect to the landscape structure. In other words, when the landscape structure is designed to consist of gardens, lawns, shrubs, and trees, the water sprinkle system must be correspondingly arranged to cover the four sections. In addition, the water sprinkle system must also pre-set the water sprinkling volume for each section because the four sections require different water sprinkling volumes for gardens, lawns, shrubs, and trees. Once the water sprinkle system is set, the user is unable to re-arrange each of the sections. Therefore, if the user wants to re-arrange the locations of the sections, he or she must re-configure the water sprinkle system.

While most water sprinkle systems are buried under ground and are not easy to modify the layout of the pipelines and sprinkle heads 40. Using the self-controllable device of the present invention, the user can simply adjust the flow adjustor 23 of the sprinkle arrangement to control the water spray of each sprinkle head 40 to optimize the watering sprinkle system. Accordingly, the water sprinkle system incorporating with the self-controllable device of the present invention, as a universal water sprinkle system, can be pre-configured with respect to the landscape structure for different sections thereof.

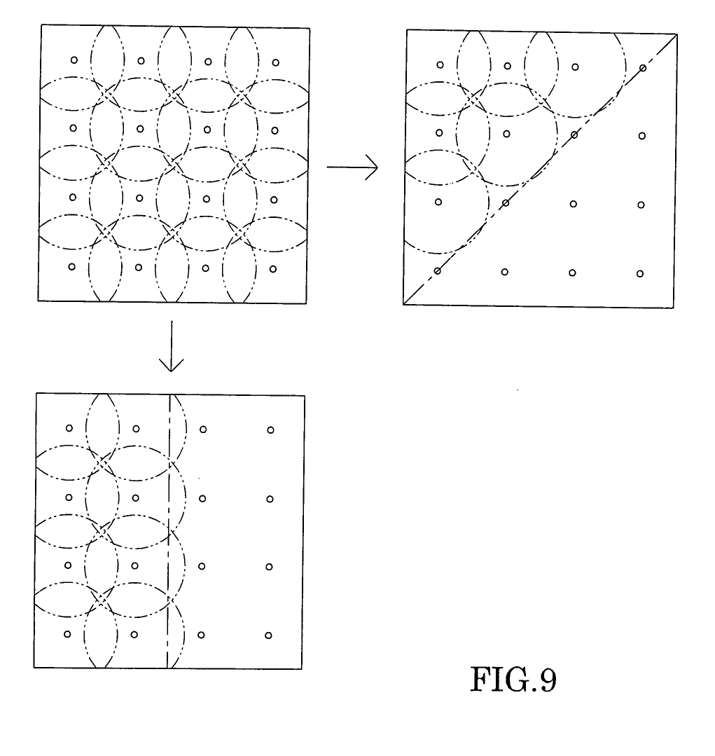

Referring to FIG. 9, for example, for a 4 by 4 water sprinkle system, the 16 self-controllable devices can be turned on all together to allow the 16 sprinkle heads 40 to spray water. The whole area will be watered. Alternatively, the left 8 self-controllable devices can be turned on, while the right 8 self-controllable devices can be shut off so the left half of the area will be watered. Alternatively, the left up 6 self-controllable devices can be turned on, while the rest 10 self-controllable devices are shut off so the left up corner of the area is watered.

In addition, by selectively adjusting the flow adjustor 23, the water sprinkling volume can correspondingly be adjusted. The user is able to fully open the flow adjustor 23 to increase the water sprinkling volume, to partially open the flow adjustor 23 to reduce the water sprinkling volume, or to close the flow adjustor 23 to block the water. Therefore, when the user wants to re-arrange the locations of the sections as mentioned above, he or she is able to selectively adjust the flow adjustor 23 without re-configuring the entire water sprinkle system.

It is worth mentioning that the self-controllable device can also be incorporated with the sprinkle head to control the operation thereof without altering the structure of the water pipeline 30. In other words, the self-controllable device can be built-in with the sprinkle head to couple with the existing water pipeline so as to self-control the operation of the sprinkle head. Therefore, the pipe joint 10 is formed at the root portion of the sprinkle head to operatively couple with the water pipeline 30 while the water regulator 20 is built-in with the sprinkle head that the sprinkle opening 24 is formed at the sprinkle head.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A self-controllable device for a sprinkle arrangement of a water sprinkle system which comprises a water pipe line, comprising:
a pipe joint having a water channel adapted for operatively coupling with said water sprinkle system to guide a water flow passing from said water pipe line to said water channel; and
a water regulator, which is coupled with said pipe joint, comprising a regulator body having a water detouring passage operatively communicating with said water channel and a sprinkle opening communicating with said water detouring passage, and a flow adjuster operatively extended within said water detouring passage for selectively controlling said water flow passing from said water channel to said water detouring passage in such a manner that when said flow adjustor is actuated for blocking said water flow passing to said water detouring passage, said respective sprinkle opening is shut off.

2. The self-controllable device, as recited in claim 1, wherein said pipe joint has a water inlet adapted for operatively coupling with said water pipe line to guide said water flow passing from said water pipe line to said water channel through said water inlet.

3. The self-controllable device, as recited in claim 1, wherein said regulator body has a partition wall and a water valve slot formed thereat, wherein a sidewall of said regulator body is extended from a surrounding wall of said pipe joint to communicate said water detouring passage with said water channel through said water valve slot.

4. The self-controllable device, as recited in claim 2, wherein said regulator body has a partition wall and a water valve slot formed thereat, wherein a sidewall of said regulator body is extended from a surrounding wall of said pipe joint to communicate said water detouring passage with said water channel through said water valve slot.

5. The self-controllable device, as recited in claim 3, wherein said flow adjuster, which is movably coupled with said regulator body, has a controlling end extended out of said regulator body and a stopper end alignedly extended towards said water valve slot and arranged in such a manner that when said controlling end of said flow adjuster is actuated, said stopper end thereof is sealed and engaged at said water valve slot to block said water flow passing from said water channel to said water detouring passage.

6. The self-controllable device, as recited in claim 4, wherein said flow adjuster, which is movably coupled with said regulator body, has a controlling end extended out of said regulator body and a stopper end alignedly extended towards said water valve slot and arranged in such a manner that when said controlling end of said flow adjuster is actuated, said stopper end thereof is sealed and engaged at said water valve slot to block said water flow passing from said water channel to said water detouring passage.

7. The self-controllable device, as recited in claim 4, wherein said sidewall of said regulator body is integrally and upwardly extended from said surrounding wall of said pipe joint such that said surrounding wall of said pipe joint and said sidewall of said regulator body integrally form said partition wall between said water channel and said water detouring passage.

8. The self-controllable device, as recited in claim 6, wherein said sidewall of said regulator body is integrally and upwardly extended from said surrounding wall of said pipe joint such that said surrounding wall of said pipe joint and said sidewall of said regulator body integrally form said partition wall between said water channel and said water detouring passage.

9. The self-controllable device, as recited in claim 4, further comprising a tubular flexible joint for coupling said regulator body with said pipe joint, wherein said flexible joint comprises two sealing ends sealedly coupling with said surrounding wall of said pipe joint and said sidewall of said regulator body respectively to retain said regulator body at a position alongside of said pipe joint so as to permit said regulator body being shifted with respect to said pipe joint.

10. The self-controllable device, as recited in claim 6, further comprising a tubular flexible joint for coupling said regulator body with said pipe joint, wherein said flexible joint comprises two sealing ends sealedly coupling with said surrounding wall of said pipe joint and a sidewall of said regulator body respectively to retain said regulator body at a position alongside of said pipe joint so as to permit said regulator body being shifted with respect to said pipe joint.

11. The self-controllable device, as recited in claim 9, wherein said surrounding wall of said pipe joint has a first flat surface while said sidewall of said regulator body also has a corresponding second flat surface frictionally engaged with said first flat surface of said pipe joint via said flexible joint such that when said regulator body is pivotally shifted with respect to said pipe joint, said second flat surface of said regulator body is slidably engaged with said first flat surface of said pipe joint for minimizing a clearance between said pipe joint and said regulator body.

12. The self-controllable device, as recited in claim 10, wherein said surrounding wall of said pipe joint has a first flat surface while said sidewall of said regulator body also has a corresponding second flat surface frictionally engaged with said first flat surface of said pipe joint via said flexible joint such that when said regulator body is pivotally shifted with respect to said pipe joint, said second flat surface of said regulator body is slidably engaged with said first flat surface of said pipe joint for minimizing a clearance between said pipe joint and said regulator body.

13. The self-controllable device, as recited in claim 4, wherein said controlling end of said flow adjuster extended from said regulator body at a position above the ground to actuate said stopper end of said flow adjuster.

14. The self-controllable device, as recited in claim 8, wherein said controlling end of said flow adjuster extended from said regulator body at a position above the ground to actuate said stopper end of said flow adjuster.

15. The self-controllable device, as recited in claim 12, wherein said controlling end of said flow adjuster extended from said regulator body at a position above the ground to actuate said stopper end of said flow adjuster.

16. The self-controllable device, as recited in claim 4, further comprising a tubular sleeve having a bottom end coupling with said regulator body to encircle said controlling end of said flow adjuster and a top opening end extended above the ground in such a manner that when said water pipe line is embedded under the ground, said controlling end of said flow adjuster is adapted to be actuated through said tubular sleeve to actuate said stopper end of said flow adjuster.

17. The self-controllable device, as recited in claim 8, further comprising a tubular sleeve having a bottom end coupling with said regulator body to encircle said controlling end of said flow adjuster and a top opening end extended above the ground in such a manner that when said water pipe line is embedded under the ground, said controlling end of said flow adjuster is adapted to be actuated through said tubular sleeve to actuate said stopper end of said flow adjuster.

18. The self-controllable device, as recited in claim 12, further comprising a tubular sleeve having a bottom end coupling with said regulator body to encircle said controlling end of said flow adjuster and a top opening end extended above the ground in such a manner that when said water pipe line is embedded under the ground, said controlling end of said flow adjuster is adapted to be actuated through said tubular sleeve to actuate said stopper end of said flow adjuster.

19. The self-controllable device, as recited in claim 14, wherein said flow adjuster is rotatably coupled with said regulator body that said controlling end of said flow adjuster forms a screw head adapted for being driven to rotate via a hand tool, while said stopper end of said flow adjuster forms a sealing stopper driven to seal at said water valve slot.

20. The self-controllable device, as recited in claim 15, wherein said flow adjuster is rotatably coupled with said regulator body that said controlling end of said flow adjuster forms a screw head adapted for being driven to rotate via a hand tool, while said stopper end of said flow adjuster forms a sealing stopper driven to seal at said water valve slot.

21. The self-controllable device, as recited in claim 17, wherein said flow adjuster is rotatably coupled with said regulator body that said controlling end of said flow adjuster forms a screw head adapted for being driven to rotate via a hand tool, while said stopper end of said flow adjuster forms a sealing stopper driven to seal at said water valve slot.

22. The self-controllable device, as recited in claim 18, wherein said flow adjuster is rotatably coupled with said regulator body that said controlling end of said flow adjuster forms a screw head adapted for being driven to rotate via a screwdriver, while said stopper end of said flow adjuster forms a sealing stopper driven to seal at said water valve slot.

23. The self-controllable device, as recited in claim 1, wherein said sprinkle opening of said regulator body has an inner threaded portion for a sprinkle head detachably mounting at said sprinkle opening.

24. The self-controllable device, as recited in claim 8, wherein said sprinkle opening of said regulator body has an inner threaded portion for a sprinkle head detachably mounting at said sprinkle opening.

25. The self-controllable device, as recited in claim 12, wherein said sprinkle opening of said regulator body has an inner threaded portion for a sprinkle head detachably mounting at said sprinkle opening.

26. The self-controllable device, as recited in claim 24, wherein said pipe joint further has a water outlet adapted for operatively coupling with said water pipe line to guide said water flow passing from said water inlet to said water pipe line.

27. The self-controllable device, as recited in claim 25, wherein said pipe joint further has a water outlet adapted for operatively coupling with said water pipe line to guide said water flow passing from said water inlet to said water pipe line.
